(19) United States
(12) Patent Application Publication
(10) Pub. No.: US 2009/0095364 A1
(43) Pub. Date: Apr. 16, 2009

(54) Fluid flow distribution and supply unit and flow distribution control program

(75) Inventors: Kazutoshi Itoh, Kani-shi (JP); Yasunori Nishimura, Kasugai-shi (JP); Keiichi Nishikawa, Tajimi-shi (JP); Akihito Sugino, Inuyama-shi (JP)

Correspondence Address: OLIFF & BERRIDGE, PLC, P.O. BOX 320850, ALEXANDRIA, VA, 22320-4850, US

(73) Assignee: CKD CORPORATION, KOMAKI-SHI (JP)

(21) Appl. No.: 12/230,928

(22) Filed: Sep. 8, 2008

(30) Foreign Application Priority Data
Oct. 15, 2007 (JP) 2007-267578

(51) Int. Cl. F16K 13/00

(52) U.S. Cl. 137/861

(57) ABSTRACT

A fluid flow distribution and supply unit for distributing and supplying a fluid is adapted to immediately control a flow rate of a fluid to be distributed and promptly output the fluid at a predetermined flow distribution ratio. The fluid flow distribution and supply unit comprises a flow rate control device for controlling a flow rate of the fluid and a plurality of on/off valves connected to a secondary side of the flow rate control device. The on/off valves are duty controlled to open and close by determining one cycle corresponding to an operation period of the on/off valves and time-dividing the one cycle at the flow distribution ratio.

### BACKGROUND OF THE INVENTION

1. Field of the Invention

The present invention relates to a fluid flow distribution and supply unit and a flow distribution control program for distributing and supplying a fluid such as a gas and a chemical liquid.

2. Description of Related Art

For instance, a chemical vapor deposition (CVD) device and an impurity doping device used in a semiconductor manufacturing process are operated in such a way that a plurality of wafers is arranged in a process chamber, the process chamber is evacuated to generate a vacuum, and then gas is introduced in the process chamber to form a thin film on each wafer in the process chamber or ionize impurities so as to introduce such ionized impurities in each wafer. For stabilizing the quality of each wafer, it is necessary to uniformize gas concentration in the process chamber.

In a recent semiconductor business field, however, there is a tendency to increase the yield of chips to be produced per wafer, thereby enhancing productivity. For this end, wafer size is shifting from 200 mm to 300 mm, conceivably to 450 mm in the future. As the wafer size is larger, the capacity of the process chamber needs to be increased inevitably. When the process chamber capacity becomes larger, gas supplied from one place is unlikely to be distributed uniformly throughout the process chamber. Accordingly, a plurality of nozzles has been arranged in the process chamber and a gas flow distribution and supply unit is disposed upstream of the process chamber to distribute the gas into each nozzle.

A conventional gas flow distribution and supply unit is provided with a mass flow controller per nozzle in order to regulate a flow rate of gas to be injected from each nozzle. However, installation of the plural mass flow controllers for a single kind of gas would need high initial cost and high running cost. Accordingly, for example JP2007-27182A proposes a technique of intermittently supplying gas from each nozzle to uniformly supply the gas throughout the process chamber.

FIG. 11 is a partly sectional front view of a conventional substrate processing device 100.

This device 100 is arranged such that a shutter not shown placed between a pressure-proof housing 101 and a process chamber 102 is opened, a boat 104 accommodating a plurality of wafers 103 is moved from the housing 101 into the process chamber 102 so at to close an opening of the shutter by a seal cap 105 fixed at a lower end of the boat 104. In the process chamber 102, a first nozzle 106a, a second nozzle 106b, and a third nozzle 106c having different lengths are placed. Each of the first, second, and third nozzles 106a, 106b, and 106c includes a distal end formed with a discharge port for discharging gas, each distal end being positioned in the process chamber 102.

Rear ends of the first to third nozzles 106a to 106c are coupled to a gas flow distribution and supply unit 110. In this unit 110, a main on/off valve 112 and a variable flow-rate control valve 113 are connected to a gas source 111. The variable flow-rate control valve 113 is connected to a first on/off valve 114a, a second on/off valve 114b, and a third on/off valve 114c arranged in parallel. These first to third on/off valves 114a to 114c are connected to the first to third nozzles 106a to 106c respectively. The main on/off valve 112, the variable flow-rate control valve 113, and the first to third on/off valves 114a to 114c are connected to and controlled in operation by a gas controller 115.

FIG. 12 is a time chart showing a conventional gas supply sequence flow.

In the aforementioned gas flow distribution and supply unit 110, the main on/off valve 112 is opened and the variable flow-rate control valve 113 is fully opened to control the flow rate of gas to a first set flow rate, and the first on/off valve 114a is opened but the second and third valves 114b and 114c remain closed. After a lapse of a fixed time (e.g. 5 sec.) from opening of the first on/off valve 114a, this valve 114a is closed. After a lapse of a predetermined time A from closing of the first on/off valve 114a, the second on/off valve 114b is opened. The variable flow-rate control valve 113 is caused to decrease its valve opening degree from a full opening condition to half thereof within a time period (the time A) from the closing of the first on/off valve 114a to the opening of the second on/off valve 114b, thereby changing the gas flow rate from the first set flow rate to a second set flow rate.

After a lapse of a fixed time (e.g. 5 sec.) from the opening of the second on/off valve 114b, this valve 114b is closed. After a lapse of a predetermined time B from the closing the second on/off valve 114b, the third on/off valve 114c is opened. The variable flow-rate control valve 113 is caused to decrease its valve opening degree from the half of the full opening condition to one-fourth of the full opening condition within a time period (the time B) from the closing of the second on/off valve 114b to the opening of the third on/off valve 114c, thereby changing the gas flow rate from the second set flow rate to a third set flow rate.

After a lapse of a fixed time (e.g. 5 sec.) from the opening of the third on/off valve 114c, this valve 114c is closed. After a lapse of a predetermined time C from the closing the third on/off valve 114c, the first on/off valve 114a is opened. The variable flow-rate control valve 113 is caused to increase its opening degree from the one-fourth of the full opening condition to the full opening condition within a time period (the time C) from the closing of the third on/off valve 114c and the opening of the first on/off valve 114a, thereby changing the gas flow rate from the third set flow rate to the first set flow rate.

The gas flow distribution and supply unit 110 is operated to repeatedly open and close the first, second, and third on/off valves 114a, 114b, and 114c in turn for each fixed time while changing the valve opening degree of the variable flow-rate control valve 113 among the first, second, and third set flow rates. The first, second, third nozzles 106a, 106b, and 106c are different in height from one another. Thus, gas will be supplied sequentially to a top area, a central area, and a bottom area in the process chamber 102 in association with the opening/closing operations of the first, second, and third on/off valves 114a, 114b, and 114c. At that time, a largest amount of gas is supplied to the top area from which the gas tends to be easily distributed throughout the process chamber 102 and a smallest amount of gas is supplied to the bottom area from which the gas is less likely to be distributed throughout the process chamber 102. Consequently, the conventional gas flow distribution and supply unit 110 could supply gas uniformly over the entire length of the wafers 103, so that the wafers 103 could be formed with thin films uniform in thickness and quality.

However, in the conventional gas flow distribution and supply unit 110, the first to third on/off valves 114a to 114c are opened and closed while the gas flow rate is changed among the first to third set flow rates by the variable flow-rate control valve 113. It is therefore necessary to delay the opening of a next one of the first to third on/off valves 114a to 114c until the flow rate of this variable flow-rate control valve 113 stabilizes. The conventional unit 110 therefore needs wasted times A, B, and C from the closing of the on/off valve up to the opening of a next on/off valve. Specifically, it usually takes 1.5 seconds or more from the time when the gas controller 115 gives a command to change the set flow rate to the variable flow-rate control valve 113 until the time this control valve 113 stabilizes the gas flow rate to the designated set flow rate. The gas flow distribution and supply unit 110 shown in FIG. 11 would produce a wasted time of 4.5 seconds or more in one cycle in which every first to third on/off valve 114a to 114c is opened and closed once.

### BRIEF SUMMARY OF THE INVENTION

The present invention has been made in view of the above circumstances and has an object to provide a fluid flow distribution and supply unit and a flow distribution control program capable of immediately controlling a flow rate of a fluid to be distributed and promptly outputting the fluid at predetermined distribution ratio.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a fluid flow distribution and supply unit for distributing and supplying a fluid, comprising: a flow rate control device for controlling a flow rate of the fluid; and a plurality of on/off valves each being connected to a secondary side of the flow rate control device, wherein the on/off valves are duty controlled at a flow distribution ratio of the fluid to be supplied in one cycle corresponding to an operation period of the on/off valves.

According to another aspect, the invention provides a flow distribution program recorded on a computer readable medium product to be used in a fluid flow distribution and supply unit for distributing and supplying a fluid through a plurality of on/off valves, wherein the program is executable to perform the steps of: controlling a controller that controls opening/closing operations of the on/off valves connected to secondary sides of a flow rate control device to duty control the on/off valves to open and close by determining one cycle corresponding to an operation period of the on/off valves and time-dividing the one cycle at a flow distribution ratio of the fluid to be supplied.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a circuit diagram of a fluid distribution and supply unit of a first embodiment according to the invention;

FIG. 2 is a plan view of a concrete embodiment of the fluid distribution and supply unit of FIG. 1;

FIG. 3 is a sectional view of the fluid distribution and supply unit taken along a line A-A in FIG. 2, in which a dashed line indicates a gas flow path;

FIG. 4 is a sectional view of on/off valves used in the fluid distribution and supply unit of FIG. 2;

FIG. 5 is an electrical block of a flow distribution controller used in the fluid distribution and supply unit of FIG. 1;

FIG. 6 is a time chart showing a gas supply sequence flow in the fluid distribution and supply unit of FIG. 1;

FIG. 7 is a circuit diagram of a fluid distribution and supply unit of a second embodiment according to the invention;

FIG. 8 is a plan view of a concrete embodiment of the fluid distribution and supply unit of FIG. 7;

FIG. 9 is a sectional view of the fluid distribution and supply unit taken along a line B-B in FIG. 8, in which a dashed line indicates a gas flow path;

FIG. 10 is a graph showing experimental results on variations in flow rate on a secondary side of the fluid flow distribution and supply unit;

FIG. 11 is a partly sectional front view of a conventional substrate processing device; and

FIG. 12 is a time chart showing a conventional gas supply sequence flow.

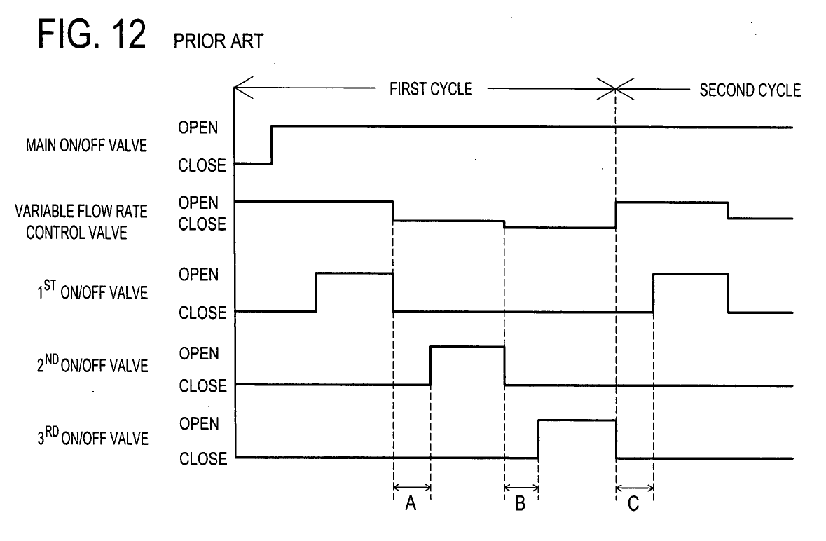

### DETAILED DESCRIPTION OF THE PREFERRED EMBODIMENTS

A detailed description of a preferred embodiment of the present invention will now be given referring to the accompanying drawings.

### First Embodiment

<Fluid Flow Distribution and Supply Unit>

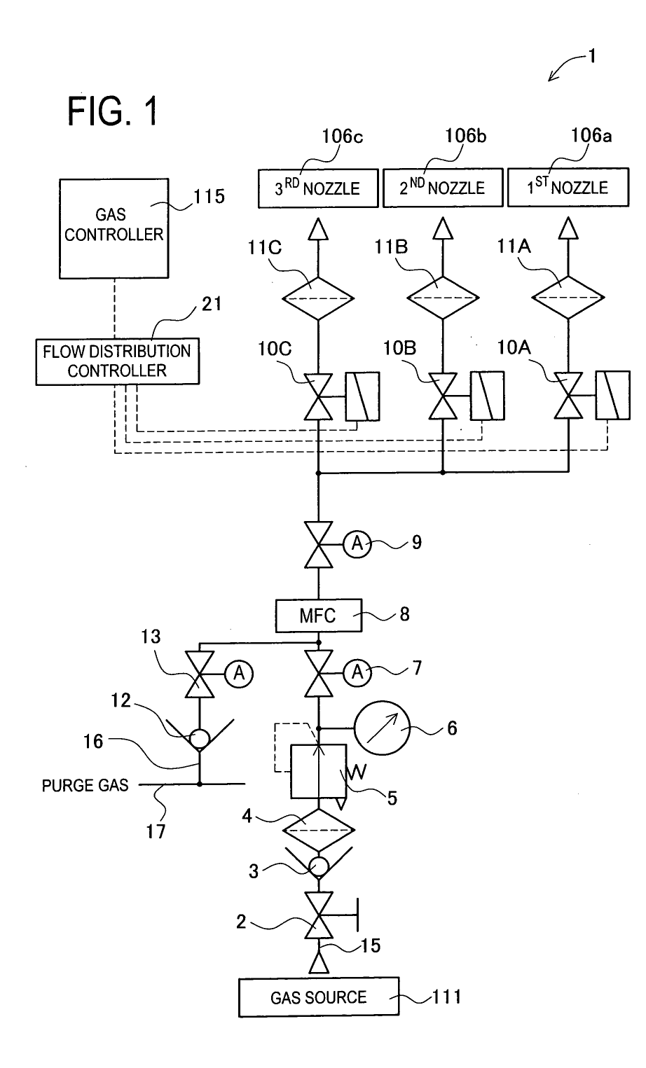

FIG. 1 is a circuit diagram of a fluid flow distribution and supply unit 1 in the first embodiment.

The fluid flow distribution and supply unit 1 is coupled to the substrate processing device 100 as in a conventional technique. This unit 1 includes a manual valve 2, a check valve 3, a filter 4, a manual regulator 5, a pressure gauge 6, an input-side air-operated valve 7, a mass flow controller (MFC) 8 which is an example of a “flow rate control device”, an output-side air-operated valve 9, first, second, and third on/off valves 10A, 10B, and 10C, and first, second, and third filters 11A, 11B, and 11C, all of which are connected to form a process gas line 15 for supply of process gas which is an example of a “fluid”. A purge gas line 16 is connected to the process gas line 15 between the input-side air-operated valve 7 and the MFC 8. The purge gas line 16 branches off from a common purge line 17 and includes a check valve 12 and the purge valve 13.

The first to third on/off valves 10A to 10C are connected individually to the gas controller 115 through a flow distribution controller 21 and controlled in opening and closing operations. The flow distribution controller 12 is placed in a gas box (not shown) in which the fluid flow distribution and supply unit 1 is accommodated when this unit 1 is manufactured.

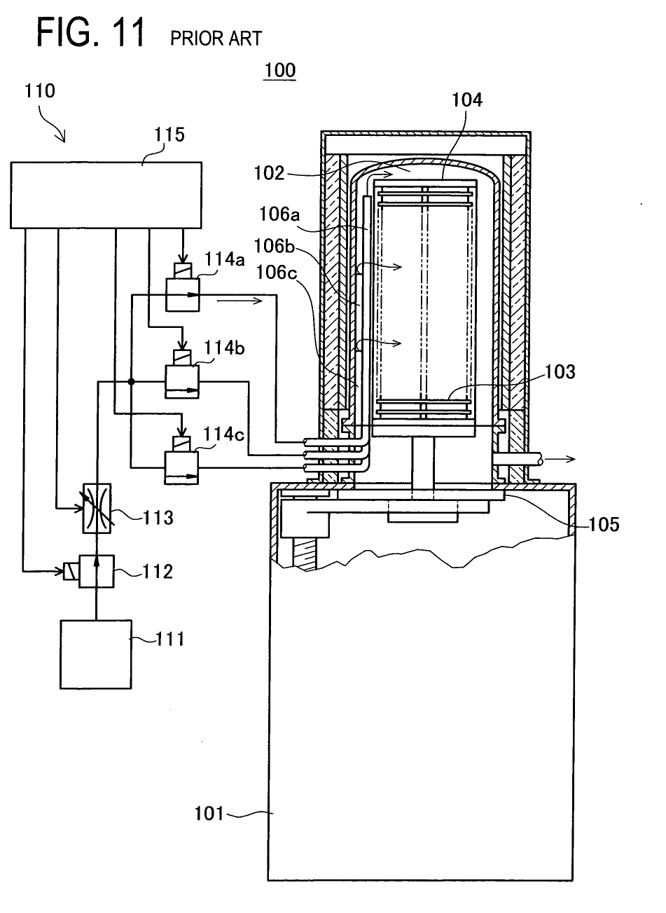

In such fluid flow distribution and supply unit 1, the manual valve 2 is connected to a gas source 111 and the first to third filters 11A to 11C are connected respectively to the first to third nozzles 106a to 106c of the process chamber 102 (see FIG. 11). In the fluid flow distribution and supply unit 1, the flow distribution controller 21 is connected to the gas controller 115 for controlling the operation of the entire substrate processing device 100 (see FIG. 11). Furthermore, in the fluid flow distribution and supply unit 1, the pressure gauge 6, input-side air-operated valve 7, MFC 8, and output-side air-operated valve 9, purge valve 13 are connected to and directly controlled by the gas controller 115.

<Concrete Configuration of Fluid Flow Distribution and Supply Unit>

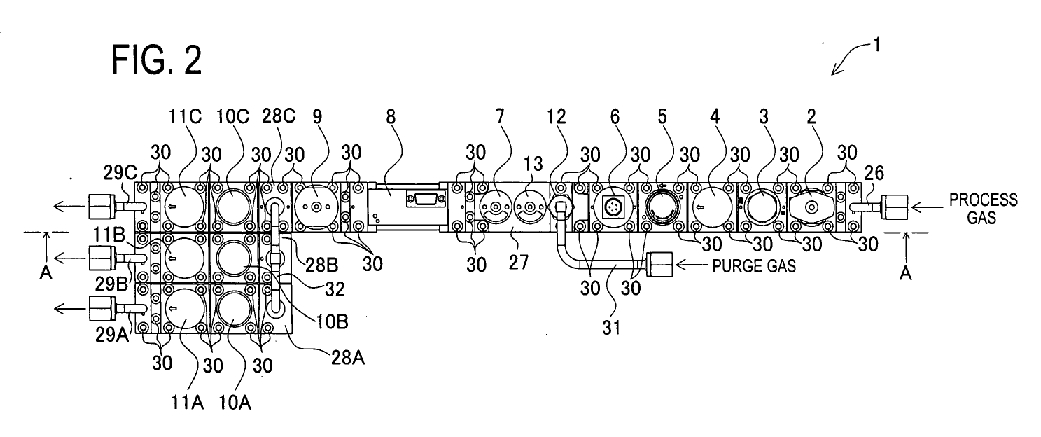

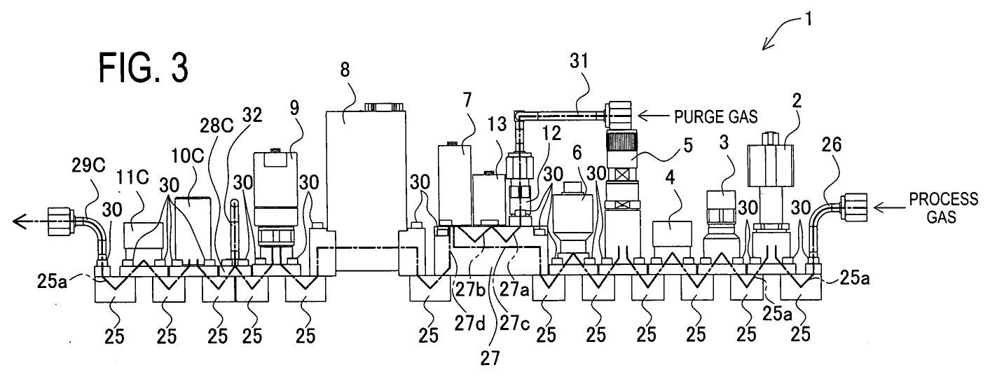

FIG. 2 is a plan view of a concrete embodiment of the fluid flow distribution and supply unit 1 of FIG. 1. FIG. 3 is a sectional view of the same taken along a line A-A in FIG. 2, in which a dashed line indicates a gas flow path.

The fluid flow distribution and supply unit 1 is made up in such a way that an input pipe 26, the manual valve 2, the check valve 3, the filter 4, the regulator 5, the pressure gauge 6, the common path block 27, the MFC 8, the output-side air-operated valve 9, first to third branch blocks 28A to 28C, the first to third on/off valves 10A to 10C, the first to third filters 11A to 11C and first to third output pipes 29A to 29C are respectively mounted and secured to flow path blocks 25 with bolts 30 tightened from above. Each flow path block 25 has a V-shaped flow path 25a with two ports opening in an upper face.

The common path block 27 is formed with a V-shaped path 27a that connects the check valve 12 and the purge valve 13 and a V-shaped path 27b that connects the purge valve 13 and the input-side air-operated valve 7. Each path 27a, 27b has openings in the upper face of the block 27. Under the V-shaped paths 27a and 27b, a process gas path 27c is formed to provide communication between the flow path block 25 on which the pressure gauge 6 is mounted and the air-operated valve 7. The common path block 27 is further formed with a common output path 27d to provide communication between the air-operated valve 7 and the flow path block 25 on which the MFC 8 is mounted.

A purge gas pipe 31 is connected from above to the check valve 21 attached to the common path block 27 in order to allow a purge gas to flow only toward the purge valve 13. The purge valve 13 is an air-operated two-port on/off valve for controlling supply and interrupt of purge gas.

The input-side air-operated valve 7 is an air-operated three-port on/off valve. This valve 7 is formed with a valve seat around an opening of the process gas path 27c and operated to bring a valve element into or out of contact with the valve seat to thereby allow or interrupt communication between the process gas path 27c and the common output path 27d. It is to be noted that the V-shaped path 27b and the common output path 27d always communicate with each other through a valve chamber in the air-operated valve 7.

The third branch block 28C is connected to one open end of a branch pipe 32 placed above a flow path providing communication between the flow path blocks 25. Other open ends of the branch pipe 32 are connected to upper faces of the first and second branch blocks 28A and 28B respectively. On these branch blocks 28A and 28B, the branch pipe 32 is secured with bolts 30 so that the branch pipe 32 communicates with one port of each of the branch blocks 28A and 28B opening in the upper faces blocks 25.

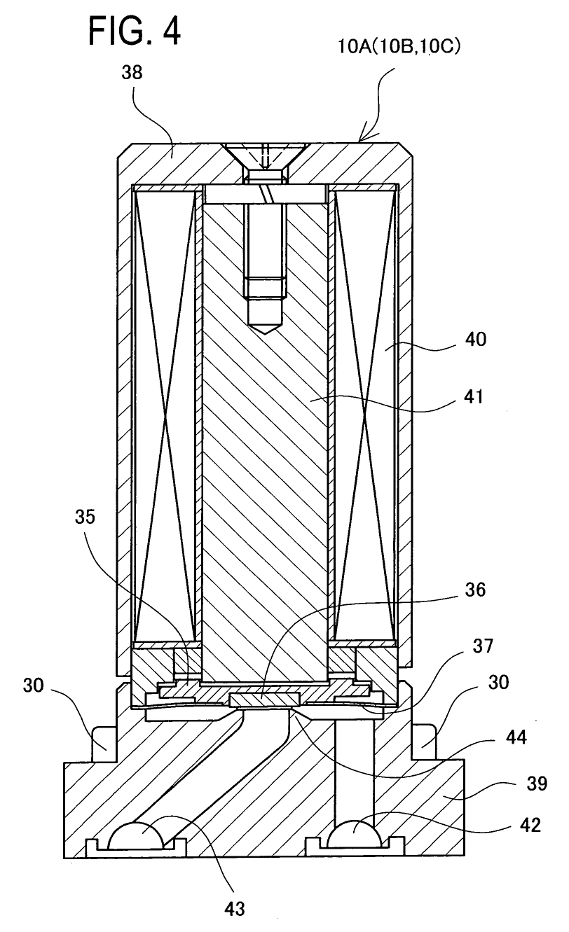

FIG. 4 is a sectional view of the on/off valve 10A (10B, 10C) shown in FIG. 2. The first, second, and third on/off valves 10A, 10B, and 10C are identical in structure and therefore only the first on/off valve 10A will be explained below without detailed explanation of the second and third on/off valves 10B and 10C.

The first on/off valve 10A is an electromagnetic valve that has a CV value sufficient to provide a designated flow rate and that can be opened and closed at high frequency. An operation period of the first on/off valve 10A is preferably determined to be a cycle causing only a small flow pulsation during opening and closing operations and ensuring high response to duty control. From this point of view, the operation period of the first on/off valve 10A is preferably determined in a range of 5 msec to 500 msec. This operation period is one cycle (100%) serving as a reference in the duty control of the first on/off valve 10A.

The first on/off valve 10A is an electromagnetic valve configured such that a periphery edge of a leaf spring 37 fixed with a movable iron core 35 and a valve plate 36 is held between a bonnet 38 and a body 39, and a fixed iron core 41 is fixed to a solenoid 40 placed in the bonnet 38. The body 39 includes a first port 42 and a second port 43 each opening in a lower face, and a valve seat 44 between the first and second ports 42 and 43. The valve plate 36 is moved into contact with the valve seat 44 by a spring force of the leaf spring 37, thereby producing valve sealing strength. Such first on/off valve 10A is placed so that the first port 42 is connected to the first branch block 28A through the flow path block 25 and the second port 43 is connected to the first filter 11A.

In the fluid flow distribution and supply unit 1 shown in FIGS. 2 and 3, the input pipe 26 is connected to a process gas pipe connected to the gas source 111 (see FIG. 11) and the purge gas pipe 31 is connected to a common purge gas pipe. Furthermore, the first to third output pipes 29A to 29C are connected to rear ends of the first to third nozzles 106a to 106c (see FIG. 11) respectively. The fluid flow distribution and supply unit 1 is thus physically incorporated in the substrate processing device 100 (see FIG. 11).

The fluid flow distribution and supply unit 1 also includes a connector (not shown) having wiring connected to the pressure gauge 6, input-side air-operated valve 7, MFC 8, output-side air-operated valve 9, purge valve 13, and distribution controller 21. By connecting the connector not shown to the gas controller 115, the unit 1 is electrically connected to the substrate processing device 100.

<Flow Distribution Controller>

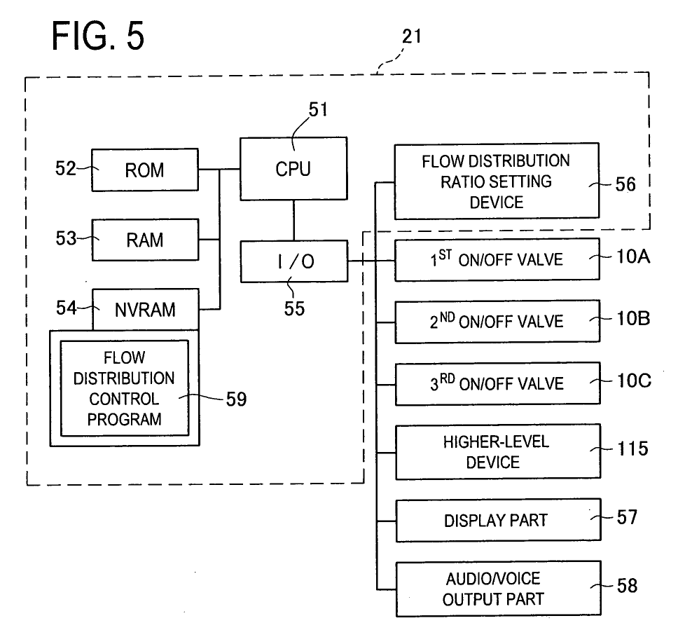

FIG. 5 is an electrical block diagram of the flow distribution controller 21 used in the fluid flow distribution and supply unit 1.

The flow distribution controller 21 is a well known microcomputer in which a CPU 51 for computing data is connected with a ROM 52 which is an involatile read only memory, a RAM 53 which is a volatile readable/writable memory, and an input/output interface (hereinafter, “I/O” interface) 55 for control of signal input and output, respectively.

The flow distribution controller 21 for controlling opening/closing operations of each of the first to third on/off valves 10A to 10C connected in parallel with the MFC 8 includes NVRAM 54 that have stored a flow distribution control program 59 executable for duty-controlling the opening/closing operations of each valve 10A to 10C by determining one cycle corresponding to the operation period of the first to third on/off valves 10A to 10C (e.g. a period from opening of the first valve 10A to closing of the third valve 10C) and time-dividing the one cycle at a flow distribution ratio.

The flow distribution controller 21 is further provided with a flow distribution ratio setting device 56 for setting flow distribution ratio of gas to be distributed from the first to third on/off valves 10A to 10C respectively. This flow distribution ratio setting device 56 is connected with the I/O interface 55. The I/O interface 55 is connected to the first to third on/off valves 10A to 10C respectively and further connected to a display part 57 for displaying data and messages and an audio/voice output part 58 for outputting a voice message, an alarm, or the like.

<Operations>

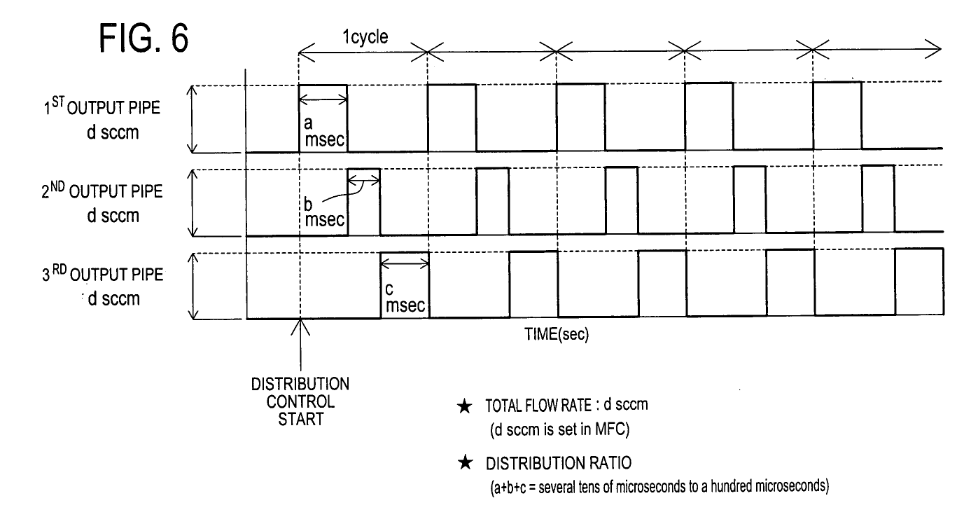

Operations of the fluid flow distribution and supply unit 1 is explained below. FIG. 6 is a time chart showing a gas supply sequence flow of the fluid flow distribution and supply unit 1 shown in FIG. 1.

When the substrate processing device 100 is activated and the gas controller 115 of the semiconductor manufacturing device starts to control the input-side air-operated valve 7, MFC 8, output-side air-operated valve 9, purge valve 13, and others, the flow fluid distribution and supply unit 1 is operated to cause the CPU 51 of the flow distribution controller 21 to read the flow distribution control program 59 from the NVRAM 54 and copy the program into the RAM 53 to execute it.

The gas controller 115 opens the shutter not shown and moves the wafers 103 from the housing 101 into the process chamber 102 while the purge valve 13, the input-side air-operated valve 7, and the output-side air-operated valve 9 remain closed. At that time, the flow distribution controller 21 holds the first to third on/off valves 10A to 10C in a closed condition.

The fluid flow distribution and supply unit 1 is then operated so that process gas supplied from the gas source 111 to the manual valve 2 is filtered by the filter 4 and delivered to the regulator 5. The gas controller 115 causes the input-side air-operated valve 7 to open to supply the process gas regulated to a set pressure to the MFC 8. After the flow rate of the MFC 8 is stabilized to a total flow rate (a set flow rate) of d sccm of the process gas to be supplied to the process chamber 102, the gas controller 115 opens the outlet-side air-operated valve 9.

The process gas is allowed to flow in the first to third on/off valves 10A to 10C via the third branch block 28C, branch pipe 32, first and second branch blocks 28A and 28B, and flow path block 25. At that time, the process gas regulated by the MFC 8 is supplied by the set flow rate of d sccm to each of the first, second, and third on/off valves 10A, 10B, and 10C.

At the same time when the output-side air-operated valve 9 is opened, the flow distribution controller 21 duty controls the first to third on/off valves 10A to 10C respectively to open and close. In other words, the fluid distribution controller 21 causes the first to third on/off valves 10A to 10C to open and close by determining one cycle corresponding to the operation period of the first to third on/off valves 10A to 10C and time-dividing the one cycle at the flow distribution ratio (a:b:c).

The flow distribution controller 21 opens the first on/off valve 10A only for a/(a+b+c) second(s) of the one cycle and then closes the first on/off valve 10A.

Concurrently with the closing of the first on/off valve 10A, the flow distribution controller 21 opens the second on/off valve 10B for b/(a+b+c) second(s) of the one cycle and then closes the second on/off valve 10B.

Concurrently with the closing of the second on/off valve 10B, the flow distribution controller 21 opens the third on/off valve 10C for c/(a+b+c) second(s) of the one cycle and then closes the third on/off valve 10C.

As above, the first, second, and third on/off valves 10A, 10B, and 10C are controlled in the one cycle.

The flow distribution controller 21 closes the third on/off valve 10C and then opens the first on/off valve 10A without delay. The above manner is repeated to duty control the first, second, and third on/off valves 10A, 10B, and 10C.

The first, second, and third on/off valves 10A, 10B, and 10C are identical in structure but different in flow rate of process gas to be outputted from the second ports 43 according to respective open times. Accordingly, the process gas is outputted into the process chamber 102 at different flow rates among the top area, the central area, and the bottom area from the first to third nozzles 106a to 106c through the first to third pipes 29A to 29C.

In the fluid flow distribution and supply unit 1, the flow paths are purged prior to maintenance. Concretely, the fluid flow distribution and supply unit 1 is operated to close the input-side air-operated valve 7 and simultaneously open the purge valve 13, supply purge gas from the purge valve 13 to the process chamber 102 via the MFC 8, output-side air-operated valve 9, first to third on/off valves 10A to 10C, first to third filters 11A to 11C, and first to third nozzles 106a to 106c, thereby replacing the process gas with the purge gas. After completion of a purging work, the MFC 8, the first to third on/off valves 10A to 10C, and others are demounted for maintenance.

<Concrete Example>

For instance, an example is explained to supply process gas to the process chamber 102 by 20 sccm for the top area, 50 sccm for the central area, and 30 sccm for the bottom area. In this case, the set flow rate of the MFC 8 is set to 100 sccm which is a total flow rate of the process gas to be supplied to the process chamber 102.

In the case where the operation period of the first to third on/off valves 10a to 10C is 100 msec, the flow distribution controller 21 causes the first on/off valve 10A to open and close at 20% (20 msec) of the one cycle, the second on/off valve 20B to open and close at 50% (50 msec) of the one cycle, and the third on/off valve 20C to open and close at 30% (30 msec) of the one cycle in accordance with the flow rate of process gas (20 sccm, 50 sccm, 30 sccm) to be supplied by the fluid flow distribution and supply unit 1 to the process chamber 102 via the first to third output pipes 29A to 29C and the first to third nozzles 106a to 106c.

Accordingly, the fluid flow distribution and supply unit 1 supplies process gas at different flow rates based on a predetermined distribution ratio (20:50:30) from the first to third on/off valves 10A to 10C to the first to third nozzles 106a to 106c respectively.

<Operations and Advantages of the Fluid Flow Distribution and Supply Unit of the First Embodiment>

According to the fluid flow distribution and supply unit 1 and the flow distribution control program 59 of the first embodiment, as mentioned above, while process gas is regulated to a set flow rate of d sccm by the MFC 8, the first to third on/off valves 10A to 10C are duty controlled to open and close by determining one cycle corresponding to the operation period of the first to third on/off valves 10A to 10C and time-dividing the one cycle at the distribution ratio of a:b:c, thereby distributing and supplying the process gas at different flow rates to the process chamber 102. At that time, the fluid flow distribution and supply unit 1 regulates the flow rates of process gas by an open time of each on/off valve 10A, 10B, 10C without changing the set flow rate of the MFC 8. The fluid flow distribution and supply unit 1 and the flow distribution control program 59 of the first embodiment need no waiting time (delay time) from the closing of the first on/off valve 10A to the opening of the second on/off valve 10B to stabilize the set flow rate of the MFC 8. It is therefore possible to immediately control the flow rate of process gas to be distributed and promptly output the process gas at a predetermined distribution ratio of a:b:c.

The fluid flow distribution and supply unit 1 of the first embodiment includes the flow distribution controller 21 for duty controlling the opening/closing operations of the first to third on/off valves 10A to 10C. Therefore, the fluid flow distribution and supply unit 1 can be incorporated in the substrate processing device 100 and operated by simple connection of the flow distribution controller 21 to the gas controller 115 of the substrate processing device 100 by wiring, without the need to install the flow distribution control program 59 in the gas controller 115 and set various conditions.

### Second Embodiment

A fluid flow distribution and supply unit of a second embodiment according to the present invention will be explained below.

<Entire Configuration of the Fluid Flow Distribution and Supply Unit>

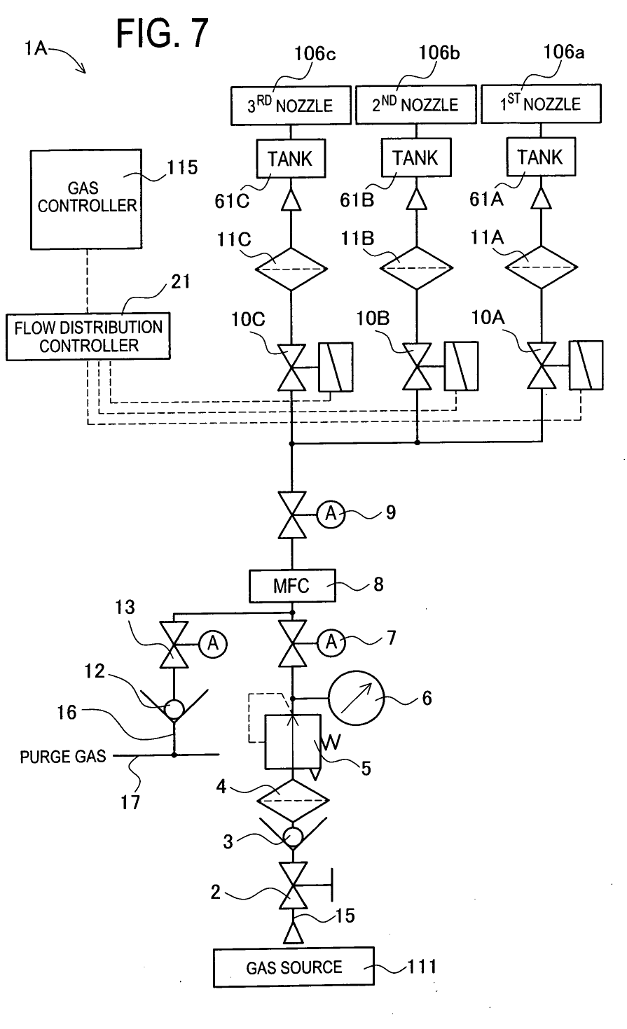

FIG. 7 is a circuit diagram of a fluid flow distribution and supply unit 1A of the second embodiment. This unit 1A is identical in structure to that of the first embodiment excepting addition of first, second, and third tanks 61A, 61B, and 61C. Accordingly, the following explanation is focused on the differences from the first embodiment and identical parts or components to those in the first embodiment are given the same reference codes without repeating the details thereof.

In the fluid flow distribution and supply unit 1A, the first, second, and third tanks 61A, 61B, and 61C are arranged on secondary sides of the first, second, and third filters 11A, 11B, and 11C respectively. The tanks 61A to 61C have equal volumes but may have different volumes in conformity to a distribution ratio (duty ratio).

<Concrete Configuration of the Fluid Flow Distribution and Supply Unit>

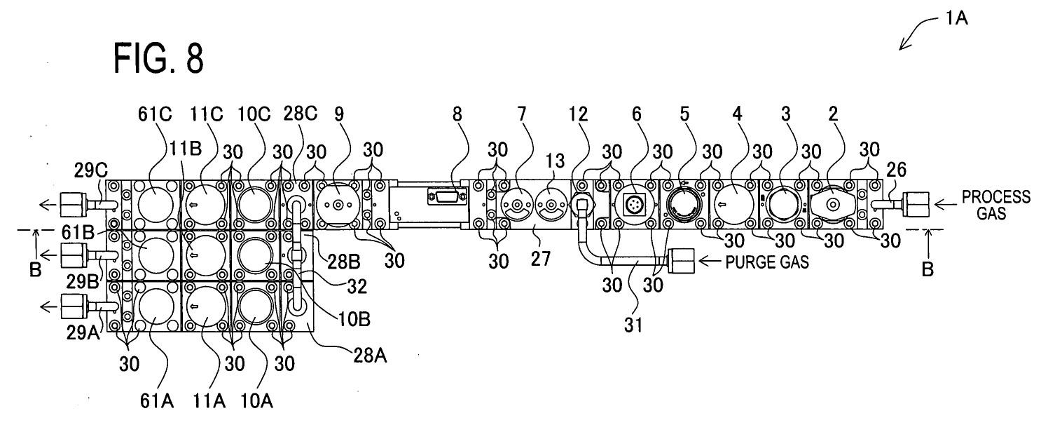

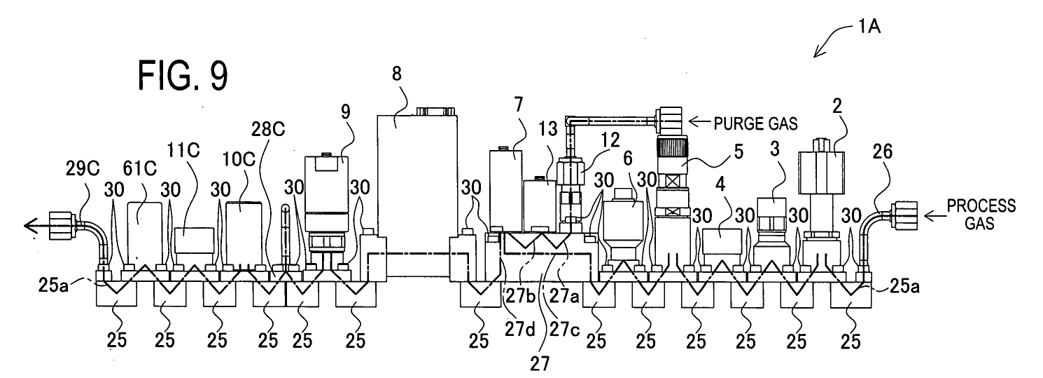

FIG. 8 is a plan view of a concrete example of the fluid flow distribution and supply unit 1A of FIG. 7. FIG. 9 is a sectional view of the fluid flow distribution and supply unit 1A taken along a line B-B in FIG. 8, in which a dashed line indicating a gas flow path.

The first, second, and third tanks 61A, 61B, and 61C have inlet ports that communicate with the filters 11A, 11B, and 11C respectively through the flow path blocks 25 and outlet ports that communicate with the first, second, and third output pipes 29A, 29B, and 29C respectively through the flow path blocks 25.

<Operations>

In the fluid flow distribution and supply unit 1A, the process gas outputted from the first to third on/off valves 10A to 10C are filtered through the first to third filters 11A to 11C to remove impurities therefrom. The fluid flow distribution and supply unit 1A is configured to once store the process gas at a regulated flow rate in the first to third tanks 61A to 61C and then supply the gas to the process chamber 102 through the first to third output pipes 29A to 29C and the first to third nozzles 106a to 106c.

Herein, the applicants conducted an experiment to examine a relationship between the presence/absence of the tanks 61A to 61C and the volumes thereof and flow rate variations of gas outputted from the first to third output pipes 29A to 29C.

This experiment used an experimental device X corresponding to the fluid flow distribution and supply unit 1A of FIG. 8 from which the first to third tanks 61A to 61C are removed, an experimental device Y including the first to third tanks 61A to 61C each having a volume of 500 cc, and an experimental device Z including the first to third tanks 61A to 61C each having a volume of 5 L. Each experimental device X, Y, Z was provided with the first to third on/off valves 10A to 10C with an operation period (cycle) of 150 msec.

In the experiment, each of the first to third on/off valves 10A to 10C was operated to output a gas of 50 msec and the set flow rate of the MFC 8 was set to 100 sccm. Accordingly, the experiment of each of the experimental devices X, Y, and Z was conducted by controlling the first to third on/off valves 10A to 10C to open and close at a ratio of 33.33% in one cycle by the flow distribution controller 21. In the experiment, nitrogen gas was used. In the experiment, furthermore, a flow meter was attached to the first output pipe 29A communicating with the first on/off valve 10A in each experimental device X, Y, Z to measure a flow rate of nitrogen gas outputted from the first output pipe 29A.

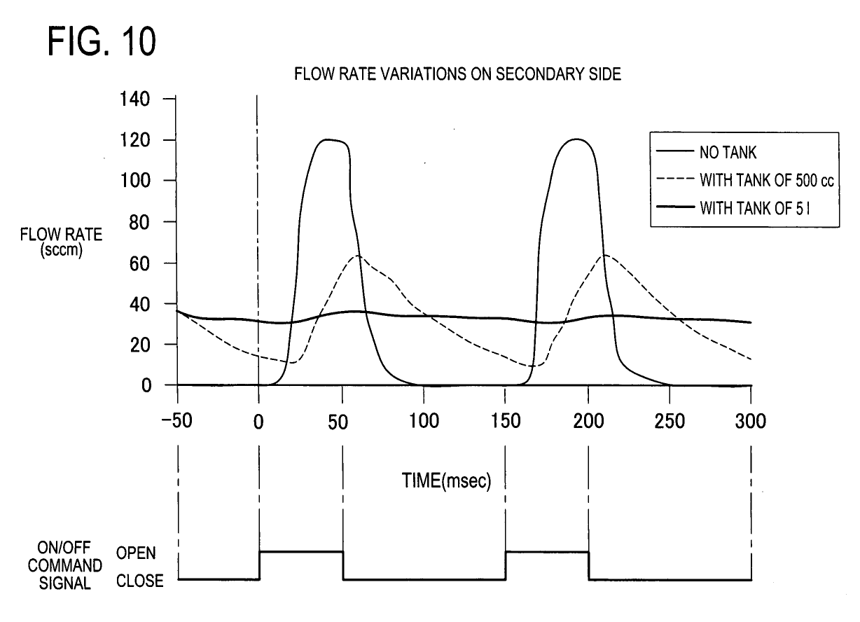

FIG. 10 is a graph showing experimental results on variations in flow rate on a secondary side of each fluid flow distribution and supply unit. In the figure, an open/close command signal represents a signal to command opening/closing of each of the on/off valve 10A. In the graph, a solid line indicates a gas flow rate variation on the secondary side of the experimental device X, a dotted line indicates a gas flow rate variation on the secondary side of the experimental device Y, and a bold line indicates a gas flow rate variation on the secondary side of the experimental device Z.

As shown in FIG. 10, the experimental device X having no first to third tanks 61A to 61C outputted gas in response to the opening/closing operations of the on/off valve 10A and therefore caused a larger flow pulsation as shown by the solid line as compared with the experimental devices Y and Z each having the first to third tanks 61A to 61C. The first to third tanks 61A to 61C were less likely to cause gas flow variations, or pulsations in flow rate, on the secondary sides as a tank volume was larger.

The above experiments revealed that, among the fluid flow distribution and supply units 1A, the unit provided with the first to third tanks 61A to 61C having larger volumes on the secondary side of the first to third on/off valves 10A to 10C could supply gas at a fixed flow rate to the first to third nozzles 106a to 106c through the first to third output pipes 29A to 29C.

<Operations and Advantages of the Fluid Flow Distribution and Supply Unit of the Second Embodiment>

In the fluid flow distribution and supply unit 1A of the second embodiment, the first to third tanks 61A to 61C are arranged on the secondary sides of the first to third on/off valves 10A to 10C respectively to reduce pulsations of the flow rate of gas to be supplied to the process chamber 102 through the first to third output pipes 29A to 29C and the first to third nozzles 106a to 106c. This makes it easy to control the flow rate of gas. This advantage can be achieved more reliably as the volumes of the first to third tanks 61A to 61C are larger.

The fluid flow distribution and supply unit 1A of the second embodiment can reduce pulsations of the flow rate of gas to be distributed and supplied. It is therefore possible to prevent deposits accumulated in the path flows of the unit 1A, the first to third nozzles 106a to 106c, and the process chamber 102 from being stirred up by the pulsations of the flow rate of gas.

In the case where the substrate processing device 100 is used for a plasma CVD process and a plasma doping process, the flow pulsations of the process gas to be supplied to the process chamber 102 may affect plasma, leading to an unstable product quality. In this regard, the fluid flow distribution and supply unit 1A of the second embodiment can reduce the pulsations of the flow rate of gas to be outputted to the process chamber 102 and hence can minimize adverse influences to plasma to provide stable product quality.

Herein, depending on an installation place of the fluid flow distribution and supply unit 1A, the first to third tanks 61A to 61C having larger volumes (e.g. 5 L or more) are not permitted to be mounted in the fluid flow distribution and supply unit 1A. Even in such a case, for example, when the fluid flow distribution and supply unit 1A is placed so far from the process chamber 102 that the first to third output pipes 29A to 29C are connected to the first to third nozzles 106a to 106c respectively by connection pipes having an entire length exceeding 2 m, the connection pipes may be utilized instead of the first to third tanks 61A to 61C placed on the secondary sides of the first to third on/off valves 10A to 10C.

The present invention is not limited to the above embodiment(s) and may be embodied in other specific forms without departing from the essential characteristics thereof.

(1) For instance, as an alternative to the above embodiments in which the three, first to third on/off valves 10A to 10C are connected to the MFC 8, two on/off valves or four or more on/off valves may be connected to the MFC 8.

(2) In the above embodiments, for example, the first to third on/off valves 10A to 10C are electromagnetically operated, but instead, the on/off valves 10A to 10C may be pneumatically operated only if it has a CV value sufficient to provide a designated flow rate and high response.

(3) In the above embodiments, the MFC 8 is used as one example of a flow rate control device. Instead thereof, a mass flow manometer may be used.

(4) The manual regulator 5 is used in the above embodiment, but instead an electronic regulator may be adopted.

(5) In the above embodiments, for example, it is arranged to transmit the flow distribution ratio to the flow distribution controller 21 through flow distribution ratio setting device 56.

As an alternative, the flow distribution controller 21 may be configured to receive a signal representing the flow distribution ratio from the gas controller 115.

(6) The fluid flow distribution and supply unit in the above embodiments is used for distributing gas, but may be employed for a chemical liquid or another.

(7) In the above embodiments, the flow distribution control program 59 is previously stored in the flow distribution controller 21. The fluid flow distribution and supply unit 1 may be made up without the flow distribution controller 21. In this case, a user copies the flow distribution control program 59 from a storage medium such as a CD-ROM to the gas controller 115 by a user so that the first to third on/off valves 10A to 10C are duty controlled by the gas controller 115.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A fluid flow distribution and supply unit for distributing and supplying a fluid, comprising:
a flow rate control device for controlling a flow rate of the fluid; and
a plurality of on/off valves each being connected to a secondary side of the flow rate control device,
wherein the on/off valves are duty controlled at a flow distribution ratio of the fluid to be supplied in one cycle corresponding to an operation period of the on/off valves.

2. The fluid flow distribution and supply unit according to claim 1, further comprising a plurality of tanks placed respectively on secondary sides of the on/off valves.

3. The fluid flow distribution and supply unit according to claim 1, further comprising a controller for duty controlling opening/closing operations of the on/off valves.

4. The fluid flow distribution and supply unit according to claim 2, further comprising a controller for duty controlling opening/closing operations of the on/off valves.

5. A flow distribution program recorded on a computer readable medium product to be used in a fluid flow distribution and supply unit for distributing and supplying a fluid through a plurality of on/off valves, wherein the program is executable to perform the steps of:
controlling a controller that controls opening/closing operations of the on/off valves connected to secondary sides of a flow rate control device to duty control the on/off valves to open and close by determining one cycle corresponding to an operation period of the on/off valves and time-dividing the one cycle at a flow distribution ratio of the fluid to be supplied.
